(19) United States
(12) Patent Application Publication
(10) Pub. No.: US 2009/0132285 A1
(43) Pub. Date: May 21, 2009

(54) METHODS, COMPUTER PROGRAM PRODUCTS, APPARATUSES, AND SYSTEMS FOR INTERACTING WITH MEDICAL DATA OBJECTS

(75) Inventor: Rex Jakobovits, Seattle, WA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Information Solutions LLC

(21) Appl. No.: 12/262,714

(22) Filed: Oct. 31, 2008

Related U.S. Application Data
(60) Provisional application No. 60/984,295, filed on Oct. 31, 2007.

(51) Int. Cl. G06F 3/048; G06Q 10/00; G06Q 50/00; G06F 21/22

(52) U.S. Cl. 705/3; 705/2; 715/771; 726/17

(57) ABSTRACT

A method, apparatus, and computer program product are provided for interacting with medical data objects. An apparatus may include a processor configured to map a DICOM object comprising medical data content to a hierarchy of one or more containers. The processor may be further configured to provide a user interface allowing a user to view a representation of the hierarchy and access the medical data content of the one or more containers. The processor may additionally be configured to receive data that a user has added to a container. The processor may also be configured to associate the received data with the DICOM object based at least in part upon the container to which the received data was added. Corresponding methods and computer program products are also provided.

### CROSS-REFERENCE TO RELATED APPLICATIONS

This application claims priority from U.S. Provisional Application No. 60/984,295, filed Oct. 31, 2007, entitled METHODS AND SYSTEMS FOR MANAGING IMAGE-BASED RESEARCH DATA AND WORKFLOW, the contents of which are incorporated herein by reference.

### FIELD OF THE INVENTION

Embodiments of the invention relate generally to tools, methods, computer program products, apparatuses, and systems for interacting with medical data objects. Embodiments of the invention may be applied to scenarios, such as, for example, collaboratively managing images and other data for clinical research.

### BACKGROUND OF THE INVENTION

Researchers are faced with complex challenges of integrating huge volumes of data obtained from a wide range of distributed and uncoordinated systems, and sharing images and data with multidisciplinary teams within and across institutions. Images typically go through a complex workflow, e.g. they may need to be aligned, registered, and integrated with data from other sources, then analyzed, manipulated, and rendered using in-house software or scripts written for environments such as SPSS, Analyze or MATLAB. Files are typically distributed over a range of machines and stored in ad-hoc directories. When research requires cooperation between groups, bottlenecks can occur if specific personnel are unavailable to perform critical functions such as retrieving a file or generating a data set.

Custom experiment management systems are highly useful to clinical researchers. However, these systems are hard to build, requiring an expensive development effort, and specialized software developer expertise.

Several factors are making it possible for interdisciplinary researchers to collaborate and share data at unprecedented levels: the increasing availability of high-bandwidth networks, the widespread adoption of clinical connectivity standards such as DICOM and HL7, the maturation of structured vocabularies such as SNOMED, and the emergence of common interchange formats. And yet, multi-institutional collaboration remains difficult for the majority of researchers, who find themselves overwhelmed by the data management requirements of their own circumscribed projects, even without the added burdens of interfacing with remote collaborators. These burdens are compounded by the complex challenges of transforming and integrating huge volumes of heterogeneous data obtained from a wide range of distributed and uncoordinated systems.

Experiment data typically originates from a diverse array of information sources, including PACS, charts and forms, spreadsheets, research databases, electronic medical records, and a wide range of modalities. Once the data are acquired, they may need to be transformed (aligned, registered, etc.) and integrated with data from other sources, then analyzed, manipulated, and rendered using in-house software or scripts written for environments such as SPSS, Analyze or MATLAB. These steps often involve the execution of a complex chain of interactive processes. Input and output files are typically distributed over a range of machines and stored in ad-hoc directory structures using cryptic folder names that might only have meaning for the person who created them. The stages of processing may involve complex dependencies on the results of previous steps, and the workflow path often branches or loops back on itself. The experiment workflow is often poorly documented, perhaps maintained as a set of notes jotted down by the project coordinator. This state of affairs may be adequate for an individual researcher or a small tightly coordinated team, but it poses serious challenges when the experiment requires participation between remote and autonomous groups. For example, the lack of an automated notification system tied to the completion of tasks results in delays between stages and confusion over what needs to be done, by whom, and when. Progress often depends on implicit knowledge possessed by a single research assistant, creating a bottleneck if that person is unavailable to perform a critical function such as retrieving a file or generating a data set, and rendering the project vulnerable to significant setbacks in the event of personnel change.

Research projects involving images usually requires a cooperative effort from clinicians, radiology technologists, administrative personnel, and scientists from multiple disciplines and institutions. Consequently, they are burdened by the age-old problems of communicating across disparate conceptual representations, in which each group has its own “language”, with its own syntax and its own semantic conventions. Existing controlled vocabulary efforts such as SNOMED, UMLS, or CaCORE are useful in bridging semantic heterogeneity with regard to clinical models, but mapping them to individual research databases often requires a significant engineering effort, and they do not account for the idiosyncratic parameters associated with imaging workflow. The very nature of cutting-edge research often dictates that much of the investigator's data and processes can not be encompassed by agreed-upon standards. Consequently, it is important that collaborating research teams adopt knowledge management strategies to bridge their individual semantic and schematic differences. This involves each group describing their conceptual framework and metadata using formalized schemas. Once these conceptual formalisms are made explicit, they can be mapped across groups using a range of knowledge integration techniques.

Often the data collected at one facility is stored on a network that is not easily accessible from a collaborator's facility. Connectivity standards such as DICOM can be leveraged, but solving interoperability issues often requires specialized expertise that may be difficult for smaller research projects to obtain. For example, hospital firewalls may pose a problem for university labs trying to acquire MR exams, or cross-facility data exchange may be complicated by incompatible network protocols. Furthermore, the software that processes a particular lab's data may not be, readily available at a collaborator's facility, and so files are often inefficiently passed back and forth in emails, on CD-ROMS, or via bulk FTP transfer. This makes it difficult to perform day-to-day quality control of multi-site studies, as there is no easy way to view collaborator's data sets in real time, or to trace back through intermediate data to identify discrepancies.

Sharing data involves complex social, political, and legal constraints, and efforts to make data sharing mandatory have met with some resistance. Researchers are often reluctant to make their data fully accessible until they have had time to publish their own findings. An additional concern is patient identifiers, which often has to be withheld from researchers who are not directly involved in the patient's care. Identifiers can be replaced with aliases, but this complicates the process of performing follow-up studies involving ongoing clinical outcomes. Researchers are forced to adopt ad-hoc mechanisms to manage these constraints, usually resorting to overly restrictive policies in which all raw and intermediate data are withheld from the research community. Projects may benefit from mechanisms for supporting fine-grained access control that would allow researchers to define custom roles and authentication strategies, and to specify multiple views over different subsets of data.

A Web-Based Experiment Management System (WEMS) is more effective when it is custom-tailored for a specific project or community. The variability of experiment data models and workflow often dictates that each WEMS must be designed in-house by stitching together many disparate tools and applications. Existing systems are usually limited in capabilities and represent a significant investment of effort that could have better been applied to the actual research itself.

Accordingly, it may be advantageous to provide methods, apparatuses, computer program products, and systems for interacting with medical data objects.

### BRIEF SUMMARY OF THE INVENTION

Methods, apparatuses, computer program products, and systems are therefore provided, which may facilitate interaction with medical data objects. In this regard, some embodiments of the invention may provide several advantages to a user of a computing device seeking to view and manipulate medical data, such as Digital Imaging and Communications in Medicine (DICOM) objects. Embodiments of the invention may map one or more DICOM objects to a hierarchy of one or more containers, which may be modeled as a hierarchy of folders having a parent folder and in some instances one or more levels of “subfolders” logically residing “beneath” the level of the parent folder. Embodiments of the invention may allow a user to add data to a DICOM object by adding data to a container to which the DICOM object was mapped. Some embodiments of the invention may provide for administration of access permissions to manage user access to medical data content in a container.

In one exemplary embodiment, a method is provided, which may include mapping a DICOM object comprising medical data content to a hierarchy of one or more containers. The method may further include providing a user interface allowing a user to view a representation of the hierarchy and access the medical data content of the one or more containers. The method may also include receiving data that a user has added to a container. The method may additionally include associating the received data with the DICOM object based at least in part upon the container to which the received data was added.

In another exemplary embodiment, a computer program product is provided. The computer program product includes at least one computer-readable storage medium having computer-readable program instructions stored therein. The computer-readable program instructions may include a plurality of program instructions. Although in this summary, the program instructions are ordered, it will be appreciated that this summary is provided merely for purposes of example and the ordering is merely to facilitate summarizing the computer program product. The example ordering in no way limits the implementation of the associated computer program instructions. The first program instruction is for mapping a DICOM object comprising medical data content to a hierarchy of one or more containers. The second program instruction is for providing a user interface allowing a user to view a representation of the hierarchy and access the medical data content of the one or more containers. The third program instruction is for receiving data that a user has added to a container. The fourth program instruction is for associating the received data with the DICOM object based at least in part upon the container to which the received data was added.

In another exemplary embodiment, an apparatus is provided, which may include a processor. The processor may be configured to map a DICOM object comprising medical data content to a hierarchy of one or more containers. The processor may be further configured to provide a user interface allowing a user to view a representation of the hierarchy and access the medical data content of the one or more containers. The processor may additionally be configured to receive data that a user has added to a container. The processor may also be configured to associate the received data with the DICOM object based at least in part upon the container to which the received data was added.

Some embodiments of the invention may allow investigators to more easily acquire and manage multimedia research data, and to selectively share data and images with collaborators. Embodiments of the invention may enable investigators to securely and selectively link data and images for easy access by demographics, physiologic properties, and experiment attributes.

Embodiments of the invention may greatly reduce the effort required to build a custom experiment management system, allowing researchers to benefit from advances in biomedical content management and collaborative knowledge sharing technologies.

An embodiment of the invention may address at least some common challenges in collaborative research management and data sharing as further described below:

Embodiments the invention manage images and associated metadata for basic research and clinical trials by unifying distributed PACS and other archives with drag-and-drop file management systems, in the context of a high level application development framework that allows researchers to construct their own custom data collection and reporting systems. Embodiments of the invention enable investigators to securely and selectively control access to images, data and files at a fine granularity, and deploy workflow management solutions that lead to increased productivity, reduced errors, and improved process repeatability. Embodiments of the invention make it easier for groups of collaborating researchers to achieve their own multi-user web-based systems for managing imaging data and workflow. Embodiments of the invention combine clinical connectivity, workflow technologies, and digital asset management solutions into a unified framework for supporting cross-facility imaging research collaboration, allowing researchers to rapidly construct and deploy multi-user web-based applications that are custom-tailored for their own unique requirements. Embodiments of the invention offer customizable data collection forms, drag-and-drop experiment object management, and integrated image viewing & annotation tools.

Embodiments of the invention offer tools for the collection, annotation, and dissemination of images and other experiment data. Embodiments of the invention generate customizable web forms for entering structured experiment data and allows users to upload files of any type into a multimedia document repository. Additionally, researchers are able to leverage connectivity interfaces for acquiring data from clinical systems, including DICOM-compliant PACS or modalities, HL7-compliant patient record systems, and any XML-based data source. Authorized users can invoke embodiments of the invention's intuitive web-based navigator to explore data sets, view images, generate reports, and pose ad-hoc queries over any combination of attributes. Because these interfaces are purely web-based, research can easily bridge multiple facilities and institutions without requiring any software deployment and maintenance efforts.

Using embodiments of the invention's modeling tools, project members are able to construct schemas that capture the unique attributes, relationships, and metadata of their experiment models. Embodiments of the invention offer an integrated web-based ontology manager that allows researchers to easily import and edit ontologies, which can then be integrated into the user interfaces for reporting, annotating, querying, and navigating experiment data. Schema descriptions and metadata are readily accessible from the data navigator, allowing researchers to easily compare parameters across data sets and protocols.

Embodiments of the invention include a policy manager that enables project leaders to securely and selectively control access to data and files at a fine granularity, on a subject-by-subject and user-by-user basis, and to create custom reports showing different views over the data for different users and in different contexts.

Embodiments of the invention include a workflow manager that expedites data acquisition and processing through streamlined coordination of the stages of the experiment lifecycle. Embodiments of the invention allow researchers to identify actions to be performed, associate those actions with software applications or executable scripts, map the flow of data between those processes, and designate the roles of users who can be called upon to interact with the workflow. Embodiments of the invention enable these actions to be pipelined together and controlled from a console, thereby eliminating bottlenecks and reducing the delay between stages of processing. For example, the system can automatically execute sequential processes that don't require user interaction, and send email alerts when a project member's attention is required. The system can be tightly integrated with the repository, automatically coordinating the inputs and outputs of participating processes, thereby relieving researchers of the burden of managing files and metadata, allowing them to interact with their data at a more natural level of abstraction. The console provides an overview of what remains to be done for each experiment subject and an audit trail for every transaction that was performed, allowing remote project members to securely monitor each other's experiments.

Some embodiments of the invention consist of two main applications: the EMS Designer, for creating a declarative specification of an experiment environment, and the EMS Generator, for translating the specification into an executable application. System developers use the EMS Designer to construct a model of the schemas, workflow, and policies that embody their experiment. The EMS Generator uses this model to create a custom WEMS for supporting the collaborative workflow and data sharing of the research group's experiment. The EMS Generator is configurable by administrators to further customize the resulting WEMS over time.

Embodiments of the invention can include a knowledge-oriented image server that allows researchers and clinicians to create and maintain centralized repositories of clinical images and their associated experiment data, and to securely transmit and control access to the data across labs and between research collaborators. The system is extensible and can evolve to meet new requirements as they are encountered during use. Embodiments of the invention allows users to selectively share data and images with local and remote collaborators and to link data and images for easy access by demographics, physiologic properties, and experiment attributes. Embodiments of the invention provides secure web-based interfaces that maintain image data, derived data, and metadata in a centralized repository. Any type of file or exam can be imported into the repository, assigned metadata, and retrieved on demand through the web interface. Files can be sent via DICOM, uploaded through web browsers, or transferred to a secure FTP directory. Once in the repository, files can be tagged with keywords, grouped into web folders, and organized in structured hierarchies.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a system for interacting with medical data objects according to an exemplary embodiment of the present invention;

FIG. 2 illustrates a block diagram of a computing architecture suitable for practicing aspects of embodiments of the present invention;

FIG. 3 is a flowchart according to an exemplary method for mapping a DICOM object to a hierarchy of one or more containers according to an exemplary embodiment of the present invention;

FIG. 4 is a flowchart according to an exemplary method for administering user access permissions associated with medical data content in a container according to an exemplary embodiment of the present invention;

FIG. 5 illustrates a process of creating, customizing, and using an experiment management system according to an exemplary embodiment of the present invention;

FIG. 6 illustrates an example of the EMS Designer according to an exemplary embodiment of the present invention;

FIG. 7 illustrates an example of the EMS Generator according to an exemplary embodiment of the present invention;

FIG. 8 illustrates an example of an integrated image stack viewer according to an exemplary embodiment of the present invention;

FIG. 9 illustrates an example of a project navigator and project viewer according to an exemplary embodiment of the present invention;

FIG. 10 illustrates an example of an exam viewer according to an exemplary embodiment of the present invention;

FIG. 11 illustrates an example of an exam editor form with user-constructed attributes according to an exemplary embodiment of the present invention;

FIG. 12 illustrates an example of an attribute manager for assigning attributes to an exam according to an exemplary embodiment of the present invention;

FIG. 13 illustrates an example of an attribute editor according to an exemplary embodiment of the present invention; and

FIG. 14 illustrates an example of a vocabulary editor according to an exemplary embodiment of the present invention.

### DETAILED DESCRIPTION OF THE INVENTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

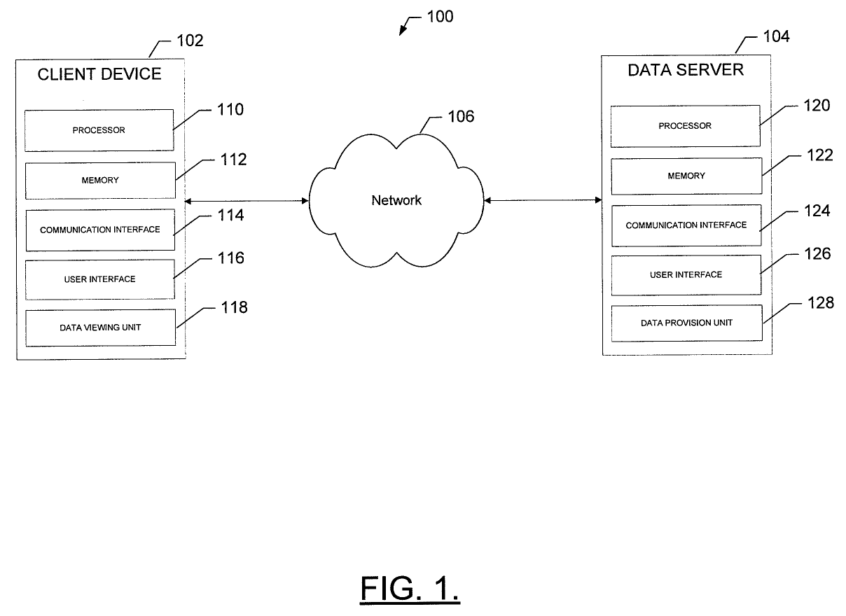

FIG. 1 illustrates a block diagram of a system 100 for interacting with medical data objects according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 1 illustrates one example of a configuration of a system for interacting with medical data objects, numerous other configurations may also be used to implement embodiments of the present invention.

As used herein, “general purpose viewing agent” refers to any means, such as may be embodied in software, hardware, firmware, or some combination thereof that may be used to access, view, and interact with content. Such content may be located remotely from the computing device on which the general purpose viewing agent is embodied and may be accessed by the general purpose viewing agent over a network, such as the internet. In an exemplary embodiment, a general purpose viewing agent may be a web browser. Further, a general purpose viewing agent as used herein may implement one or more general graphics/animation services, which are generically described to be included as part of a “general purpose viewing agent” as used herein. A “general graphics/animation service” refers to any markup or scripting language that may be implemented by a general purpose viewing agent as well as any plug-in that may be installed in a general purpose viewing agent that is generally configured for a wide range of content viewing purposes and not specifically configured for a limited purpose or application. Such general graphics/animation services may include, for example, Adobe® Flash®, Adobe® Flex®, and Microsoft® Silverlight™, as well as markup and scripting languages, such as pure HTML, Javascript, Ajax, and/or related technologies for managing, viewing, and manipulating images over the web and communicating with a data server.

Referring again to FIG. 1, the system 100 may include a client device 102 and data server 104 configured to communicate over a network 106. The client device 102 may be embodied as any computing device, mobile or fixed, and may be embodied as a server, desktop computer, laptop computer, mobile terminal, and/or the like configured to communicate with the data server 104 over the network 106. The data server 104 may be embodied as any computing device or plurality of computing devices configured to provide data, such as medical data, to a client device 102 over a network 106 as will be described further herein below. In this regard, the data server 104 may be embodied, for example, as a server cluster, rack of blade servers, and/or may be embodied as a distributed computing system, such as may be distributed across a plurality of computing devices. Although referred to herein as a “server,” it will be appreciated that the data server 104 may be embodied as a computing device other than a server. In an exemplary embodiment, the data server 104 may comprise a Picture Archiving and Communication System (PACS) and/or a PACS client. Further, although only a single client device 102 and data server 104 are illustrated in FIG. 1, the system 100 may comprise a plurality of client devices 102 and data servers 104.

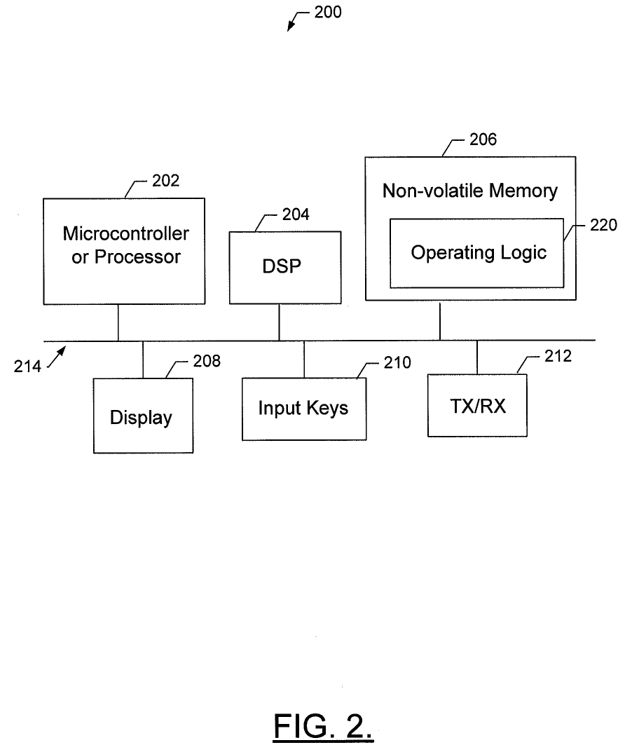

The client device 102 and/or data server 104 may comprise an architecture 200 as illustrated in FIG. 2. In this regard, the computing architecture 200 represents an architecture suitable for practicing aspects of embodiments of the present invention. The architecture 200 may include various means, such as micro-controller/processor 202, digital signal processor (DSP) 204, non-volatile memory 206, display 208, input keys 210 (e.g., 12 key pad, select button, D-unit), and/or transmit/receive unit (TX/RX) 212, coupled to each other via bus 214, which may be a single bus or an hierarchy of bridged buses. Further, non-volatile memory 206 may include operating logic 220 adapted to implement operations for practicing various embodiments of the present invention for managing, viewing, manipulating, sharing, and annotating images in a general purpose viewing agent, such as a web browser. The implementation of the operating logic 220 may be via any one of a number of programming languages, assembly, C, and so forth.

Returning to FIG. 1, the network 106 may comprise any network over which the programmer device 102 and data server 104 are configured to communicate. Accordingly, the network 106 may comprise one or more public and/or private wireless networks, wireline networks, or any combination thereof, and in some embodiments may comprise the internet. The network 106 may further comprise a structured network, ad hoc network, or some combination thereof. The network 106 may further utilize any communications protocol or combination of communications protocols that may facilitate inter-device communication between the client device 102 and data server 104.

The client device 102 may include various means, such as a processor 110, memory 112, communication interface 114, user interface 116, and data viewing unit 118 for performing the various functions herein described. These means of the client device 102 may communicate over a bus, such as the bus 214, and may be embodied as, for example, hardware elements (e.g., a suitably programmed processor, combinational logic circuit, and/or the like), computer code (e.g., software or firmware) embodied on a computer-readable medium (e.g. memory 112) that is executable by a suitably configured processing device, or some combination thereof. The processor 110 may, for example, be embodied as various means including a microprocessor, a coprocessor, a controller, or various other processing elements including integrated circuits such as, for example, an ASIC (application specific integrated circuit) or FPGA (field programmable gate array). Accordingly, the processor 110 may comprise the microcontroller 202 and/or the DSP 204 of the architecture 200. In an exemplary embodiment, the processor 110 may be configured to execute instructions stored in the memory 112 or otherwise accessible to the processor 110. Although illustrated in FIG. 1 as a single processor, the processor 110 may comprise a plurality of processors operating cooperatively and/or in parallel, such as in a multi-processor system.

The memory 112 may include, for example, volatile and/or non-volatile memory, such as the non-volatile memory 206. The memory 112 may be configured to buffer input data for processing by the processor 110. Additionally or alternatively, the memory 112 may be configured to store instructions for execution by the processor 110. The memory 112 may comprise one or more databases that store information in the form of static and/or dynamic information. The memory 112 may store, for example, operating logic for applications, such as, for example, a general purpose viewing agent as well as locally cached data, such as images or other medical data, received from the data server 104. The memory 112 may additionally or alternatively store medical case files, such as may be locally created and/or received from a remote device, such as from the data server 104. This stored information may be stored and/or used by the data viewing unit 118 during the course of performing its functionalities.

The communication interface 114 may be embodied as any device or means embodied in hardware, software, firmware, or a combination thereof that is configured to receive and/or transmit data from/to a network and/or any other device or module in communication with the client device 102. In one embodiment, the communication interface 114 may be at least partially embodied as or otherwise controlled by the processor 110. The communication interface 114 may include, for example, an antenna, a transmitter, a receiver, a transceiver and/or supporting hardware or software for enabling communications with other entities of the system 100, such as a data server 104 via the network 106. Accordingly, the communication interface 114 may be embodied as or comprise elements of the TX/RX 212. The communication interface 114 may be configured to receive and/or transmit data using any protocol that may be used for communications between the client device 102 and data server 104 over the network 106. The communication interface 114 may additionally be in communication with the memory 112, user interface 116, and/or data viewing unit 118.

The user interface 116 may be in communication with the processor 110 to receive an indication of a user input and/or to provide an audible, visual, mechanical, or other output to the user. As such, the user interface 116 may include, for example, a keyboard (e.g., input keys 210), a mouse, a joystick, a display (e.g., display 208), a touch screen display, a microphone, a speaker, and/or other input/output mechanisms. Accordingly, the user interface 116 may be configured to display medical data, such as medical images, received from a data server 104 and facilitate user interaction with medical data by receiving from a user of the client device 102 commands and/or queries related to accessing and manipulating medical data. The user interface 116 may be configured to display a graphical user interface on a display so as to facilitate user interaction with medical data. The user interface 116 may further be in communication with the memory 112, communication interface 114, and/or data viewing unit 118.

The data viewing unit 118 may be embodied as various means, such as hardware, software, firmware, or some combination thereof and, in one embodiment, may be embodied as or otherwise controlled by the processor 110. In embodiments where the data viewing unit 118 is embodied separately from the processor 110, the data viewing unit 118 may be in communication with the processor 110. In an exemplary embodiment, the data viewing unit 118 may comprise and/or control a general purpose viewing agent. The data viewing unit 118 may additionally or alternatively comprise and/or control a specific purpose medical application, such as, for example, a medical case viewer, a medical image viewer, a medical diagnostic program, a medical diagnostic training program, a medical examination system (e.g., for Continuing Medical Education (CME) credit), a collaborative clinical research management program, an experimental data management program, and/or the like. The data viewing unit 118 may comprise elements of operating logic 220.

The data viewing unit 118 may be configured to request medical data from the data server 104. The requested data may be stored remotely in a format in accordance with the Digital Imaging and Communications in Medicine (DICOM) standard data format and may comprise one or more DICOM objects. It will be appreciated, however, that embodiments of the present invention are not limited to operations using data or images in DICOM format and may operate on data and images in any appropriate format. Further, where reference is made to medical data, it will be appreciated that embodiments of the present invention have applications to other fields as well and thus any type of data may be substituted where a medical image is used for purposes of example. In this regard, the data viewing unit 118 may be configured to send a request for medical data to the data server 104. The request may be generated in response to explicit requests and/or implicit requests generated by actions taken by a user of the client device 102.

The data viewing unit 118 may be further configured to receive medical data, such as in response to a request, from the data server 104 and may, in an exemplary embodiment, cause the received medical data to be displayed on a display so that a user of the client device 102 may view and interact with the medical data. In this regard, the data viewing unit 118 may, for example, cause the received medical data to be displayed in a graphical user interface. At least a portion of the format and content of the graphical user interface may be specified by data received from the data server 104. Additionally or alternatively, at least a portion of the format of the graphical user interface may be specified by the data viewing unit 118, which may cause the received medical data to be displayed within a graphical user interface format specified by the data viewing unit 118. Accordingly, the graphical user interface format may be defined by a general purpose viewing agent and/or medical application that the data viewing unit 118 may comprise and/or control. In instances wherein the received medical data comprises one or more DICOM objects, the DICOM objects may be mapped to a hierarchy of one or more containers, such as, for example, folders, by the data server 104. Each container may comprise a subset of the medical data content of a DICOM object(s) from which the hierarchy of containers was mapped. Accordingly, the data viewing unit 118 may cause a graphical representation of the hierarchy of containers to be displayed so that a user of the client device 102 may view and interact with a representation of the hierarchy and the content contained within the containers.

A user of the client device 102 may request to view, for example, a file, image, or other data included within one of the containers. If the requested data is available locally, such as in memory 112, the data viewing unit 118 may cause the requested data to be displayed, such as in a general purpose viewing agent. If the requested data is not locally available, the data viewing unit 118 may send a request to the data server 104 and may receive the requested data in response to the request, if the user has permission to access the requested data. In this regard, the data viewing unit 118 may, in some embodiments, be configured to send an indication of the user's identity and/or an identity of the client device 102 to the data server 104, such as upon the initiation of a user session so that the data server 104 may determine whether a user of the client device 102 may access requested medical data based at least in part upon access permissions associated with a container and the underlying DICOM object(s). The data viewing unit 118 may then cause the requested data to be displayed if the user may access the requested data (e.g., if the requested data is received from the data server 104 in response to the request) or may cause an error message to be displayed if the user may not access the requested data (e.g., if the requested data is not received from the data server 104 in response to the request or if an explicit access denial is received from the data server 104).

The data viewing unit 118 may further be configured to facilitate addition of data to a container. Accordingly, a user of the client device 102 may be able to select data, such as a medical file, medical image, and/or other medical data to add to the hierarchy of containers and thus to the underlying DICOM object(s) and add the selected data to the hierarchy of containers. For example, a graphical user interface specified by the data server 104 and/or data viewing unit 118 may comprise a graphical drag and drop interface wherein the hierarchy of containers may be represented as a hierarchy of folders including a parent folder and where appropriate one or more levels of subfolders. In this regard, a user of the client device 102 may be able to select data, such as may be locally stored in the memory 112 with a cursor or other graphical selection tool and “drag” the selected data to a folder and “drop” the selected data into the folder, such as by using a mouse connected to the client device 102. The data server 104 may then send the data added to the hierarchy of containers by the user to the data server 104 so that the data server 104 may add the data to the underlying DICOM object(s). However, it will be appreciated, that the ability of a user to add data to a container may be controlled by access permissions that may be administrated by the data server 104 similarly as previously described.

Referring now to the data server 104, the data server 104 may include various means, such as a processor 120, memory 122, communication interface 124, user interface 126, and/or data provision unit 120 for performing the various functions herein described. These means of the data server 104 may communicate over a bus, such as the bus 214, and may be embodied as, for example, hardware elements (e.g., a suitably programmed processor, combinational logic circuit, and/or the like), computer code (e.g., software or firmware) embodied on a computer-readable medium (e.g. memory 122) that is executable by a suitably configured processing device, or some combination thereof. The processor 120 may, for example, be embodied as various means including a microprocessor, a coprocessor, a controller, or various other processing elements including integrated circuits such as, for example, an ASIC (application specific integrated circuit) or FPGA (field programmable gate array). Accordingly, the processor 120 may comprise the microcontroller 202 and/or the DSP 204 of the architecture 200. In an exemplary embodiment, the processor 120 may be configured to execute instructions stored in the memory 122 or otherwise accessible to the processor 110. Although illustrated in FIG. 1 as a single processor, the processor 120 may comprise a plurality of processors operating cooperatively and/or in parallel, such as a multi-processor system. These multiple processors may be embodied on a single computing device or may be distributed across multiple computing devices, such as, for example, a server cluster, rack of blade servers, or a distributed computing system.

Although illustrated as a component of a separate computing device in the embodiment illustrated in FIG. 1, the data viewing unit 118 may be embodied on the data server 104 in an alternative embodiment. In this regard, the data server 104 may comprise a client device 102 through which an end user may access and view medical data. In such an embodiment, the data viewing unit 118 may function as previously described, but may instead be embodied as or otherwise controlled by the processor 120. Further, in such an embodiment, where herein reference is made to the data viewing unit 118 sending a request to and receiving data from the data server 104, the data viewing unit 118 may be configured to send a request to and receive data from the data provision unit 128. Reciprocally, where herein reference is made to the data provision unit 128 receiving a request from and providing data to the client device 102, the data provision unit 128 may be configured to receive a request from and provide data to the data viewing unit 118.

The memory 122 may include, for example, volatile and/or non-volatile memory, such as the non-volatile memory 206. The memory 122 may be configured to buffer input data for processing by the processor 120. Additionally or alternatively, the memory 122 may be configured to store instructions for execution by the processor 120. The memory 122 may comprise one or more databases that store information in the form of static and/or dynamic information. The memory 122 may store, for example, operating logic for applications, as well as medical data, such as images (e.g. DICOM files, DICOM objects, and/or the like), that may be requested by and/or provided to a client device 102. This stored information may be stored and/or used by the data provision unit 128 during the course of performing its functionalities.

The communication interface 124 may be embodied as any device or means embodied in hardware, software, firmware, or a combination thereof that is configured to receive and/or transmit data from/to a network and/or any other device or module in communication with the data server 104. In one embodiment, the communication interface 124 may be at least partially embodied as or otherwise controlled by the processor 120. The communication interface 124 may include, for example, an antenna, a transmitter, a receiver, a transceiver and/or supporting hardware or software for enabling communications with other entities of the system 100, such as a client device 102 via the network 106. Accordingly, the communication interface 124 may be embodied as or comprise elements of the TX/RX 212. The communication interface 124 may be configured to receive and/or transmit data using any protocol that may be used for communications between the client device 102 and data server 104 over the network 106. The communication interface 124 may additionally be in communication with the memory 122, user interface 126, and/or data provision unit 128.

The user interface 126 may be in communication with the processor 120 to receive an indication of a user input and/or to provide an audible, visual, mechanical, or other output to the user. As such, the user interface 126 may include, for example, a keyboard (e.g., input keys 210), a mouse, a joystick, a display (e.g., display 208), a touch screen display, a microphone, a speaker, and/or other input/output mechanisms. The user interface 126 may further be in communication with the memory 122, communication interface 124, and/or data provision unit 128. However, in embodiments wherein the data server 104 functions solely to receive data requests from a client device 102 and provide data to a client device 102, the user interface 126 may be limited or even eliminated.

The data provision unit 128 may be embodied as various means, such as hardware, software, firmware, or some combination thereof and, in one embodiment, may be embodied as or otherwise controlled by the processor 120. In embodiments where the data provision unit 128 is embodied separately from the processor 120, the data provision unit 128 may be in communication with the processor 120.

The data provision unit 128 may be configured to map one or more DICOM object(s), such as may be stored in memory 122 to a hierarchy of one or more containers, wherein each container comprises a subset of the medical data content of the DICOM object(s). The data provision unit 128 may be configured to store a representation of a hierarchy of a DICOM object(s) in the memory 122 in advance of receiving a request for access to the DICOM object(s) from the client device 102. In this regard, the data provision unit 128 may be configured to periodically map DICOM objects that are locally stored in memory 122 and/or otherwise accessible to the data provision unit 128 over the network 106 to a hierarchy of containers. Additionally or alternatively, the data provision unit 128 may be configured to map the DICOM object(s) to a hierarchy of containers upon receipt of a request for access to a DICOM object from the client device 102. The data provision unit 128 may be configured to use an identification number that may be extracted from a header included in a DICOM object to facilitate mapping a DICOM object to a hierarchy of containers.

For example, a patient DICOM object may be associated with a particular patient and may comprise one or more exam DICOM objects associated with the patient. The data provision unit 128 may map the patient DICOM object to a hierarchy of containers such that a parent container represents the patient DICOM object and may map the medical data of each exam object to a separate sub-container or child container logically arranged one level “beneath” the parent container in the hierarchy of containers. For example, the data provision unit 128 may map a patient object associated with a patient “P1” comprising medical data from three exams (e.g., three exam objects) labeled “E1”, “E2”, and “E3” to the following hierarchy of containers:

| | | |
|---|---|---|
| | P1 | |
| E1 | E2 | E3 |

In another example, an exam DICOM object may comprise an exam identity (e.g., date of exam, modality of exam, patient associated with the exam, and/or the like) and one or more series DICOM objects associated with the exam. The data provision unit 128 may map the exam object to a hierarchy of containers such that a parent container represents the exam object and may map the medical data of each series object to a separate sub-container or child container logically arranged one level “beneath” the parent container in the hierarchy of containers. Similarly, a series DICOM object may comprise one or more DICOM images captured in as series during an examination. Each image may be mapped to a separate sub-container logically arranged one level “beneath” a parent container comprising the series or may be included within the parent container comprising the series. Thus, considering the previous example with a patient object associated with a patient “P1,” assume that exam E1 comprises two series objects “S1” and “S2” with “S1” comprising image “IMG1.” The data provision unit 128 may be configured to map the patient object to the following hierarchy of containers:

| | | | | |
|---|---|---|---|---|
| | | | P1 | |
| | E1 | | E2 | E3 |
| S1 | | S2 | | |
| IMG1 | | | | |

The data provision unit 128 may be configured to provide a representation of a hierarchy of one or more containers to which a DICOM object(s) was mapped to the client device 102, such as in response to a request received from the client device 102. In some embodiments, the data provision unit 128 may at least partially define a graphical user interface comprising a visual representation of the hierarchy of containers, which may be arranged as a hierarchy of folders, and allowing a user of the client device 102 to interact with and access medical data content of the one or more containers in the hierarchy. The data provision unit 128 may accordingly provide data comprising this definition to the client device 102.

The data provision unit 128 may receive a request for access to a subset of medical data contained within a container from the client device 102. In response to receipt of such a request, the data provision unit 128 may be configured to retrieve the requested medical data from a memory, such as the memory 122 and provide the requested medical data to the client device 102.

In some embodiments, the data provision unit 128 may be configured to determine access permissions defined by a DICOM object and map the access permissions to one or more containers to which the DICOM object is mapped. The access permissions may define individual users and/or groups of users who are permitted to access a subset of medical data of the DICOM object and/or who are denied access to a subset of medical data of the DICOM object. The access permissions may further define an extent of access permissions (e.g., may access data but may not modify data, full access privileges, and/or the like). The data provision unit 128 may be configured to associate a determined set of access permissions for a subset of medical data of the DICOM object to a container(s) to which the subset of medical data was mapped. In such embodiments, the data provision unit 128 may be configured in response to receipt of a request for access to medical data included within a container to determine an identity of a user and/or client device 102 making the request. This identity may be received, for example, with the request for access to the medical data or may have been received at the initiation of a user session. The data provision unit 128 may be further configured to determine access permissions associated with the container to which the requested medical data is mapped. The data provision unit 128 may then determine whether the user has permission to access the requested medical data content based at least in part upon the determined identity and the determined access permissions. If the user does have permission to access the medical data content, the data provision unit 128 may provide access to the requested medical data content to the requesting user, such as by sending the requested medical data content to the client device 102. If, however, the user does not have permission to access the medical data content, the data provision unit 128 may deny the user request. In this regard, the data provision unit 128 may send an error message to the effect that the user and/or client device 102 does not have sufficient access privileges to the client device 102.

The data provision unit 128 may be configured to receive data that a user of the client device 102 has added data to a container. The data provision unit 128 may be further configured to associate the received data with the DICOM object(s) from which the medical data contained in the container to which the user added the received data was mapped. In some instances, the received data may not be formatted in conformance with DICOM standards. In some embodiments, the data provision unit 128 may be configured to modify such received data so that it is compatible with a DICOM object, such as, for example, by converting the received data to DICOM format or by wrapping the received data in a DICOM file and may then associate the received data with the appropriate DICOM object(s) based at least in part upon the container to which the user added the received data. It will be appreciated that the data provision unit 128 may be configured to administer user permissions defining whether a user may add data to a container. In this regard, the data provision unit 128 may be configured to determine whether a user has sufficient access privileges to add data to a container based at least in part upon an identity of the user, client device, and/or user permissions associated with the container to which the data was added. If the user does not have sufficient access privileges, the data provision unit 128 may be configured to deny the attempt to add data to the container and may send an error message to the effect that the user and/or client device 102 does not have sufficient access privileges to the client device 102.

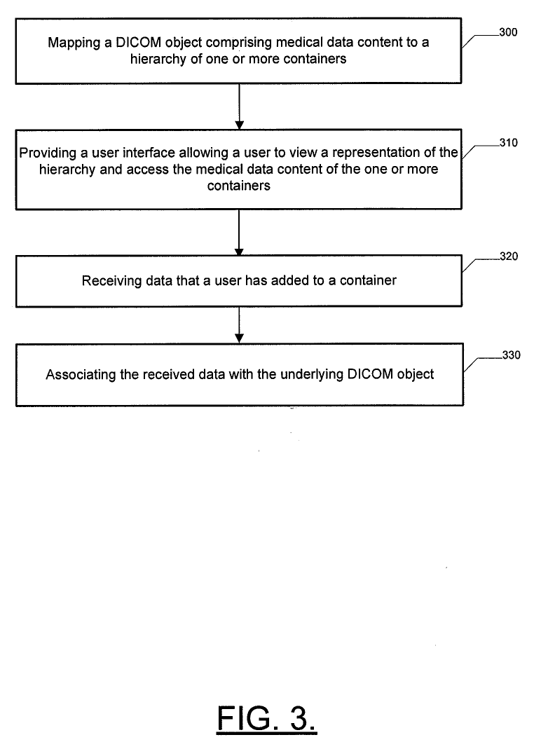

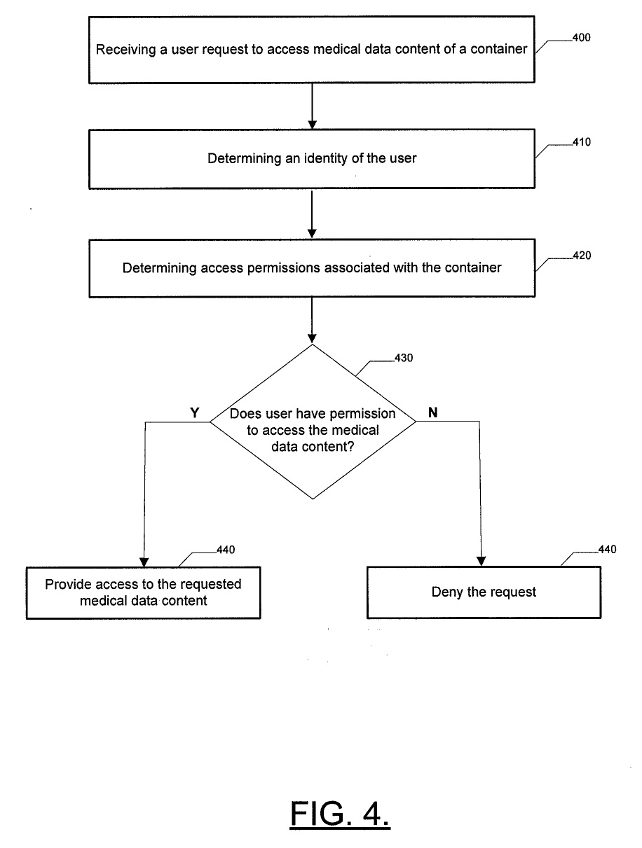

FIGS. 3-4 are flowcharts of a system, method, and computer program product according to an exemplary embodiment of the invention. It will be understood that each block or step of the flowcharts, and combinations of blocks in the flowcharts, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal, server, or other computing device and executed by a processor in the computing device. In some embodiments, the computer program instructions which embody the procedures described above may be stored by memory devices of a plurality of computing devices. As will be appreciated, any such computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, may be implemented by special purpose hardware-based computer systems which perform the specified functions or steps, or combinations of special purpose hardware and computer instructions.

In this regard, one exemplary method for mapping a DICOM object to a hierarchy of one or more containers according to an exemplary embodiment of the present invention is illustrated in FIG. 4. The method may include the data provision unit 128 mapping a DICOM object comprising medical data content to a hierarchy of one or more containers, at operation 400. The data provision unit 128 may map the DICOM object such that each container in the hierarchy of containers comprises a subset of the medical data content of the DICOM object. Operation 410 may comprise the data provision unit 128 and/or data viewing unit 118 providing a user interface allowing a user to view a representation of the hierarchy and access the medical data content of the one or more containers. The data provision unit 128 may then receive, from a client device 102, data that a user has added to a container, at operation 420. Operation 430 may comprise the data provision unit 128 associating the received data with the underlying DICOM object based at least in part upon the container to which the received data was added by the user.

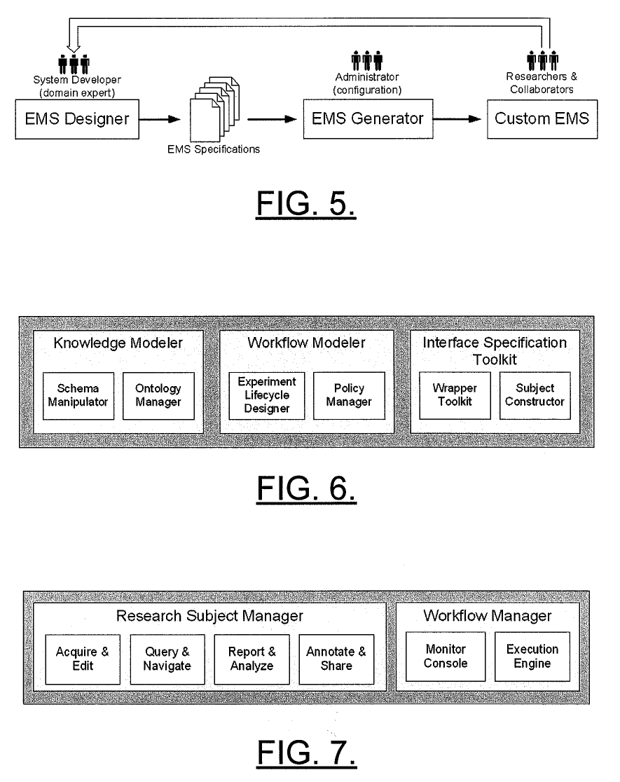

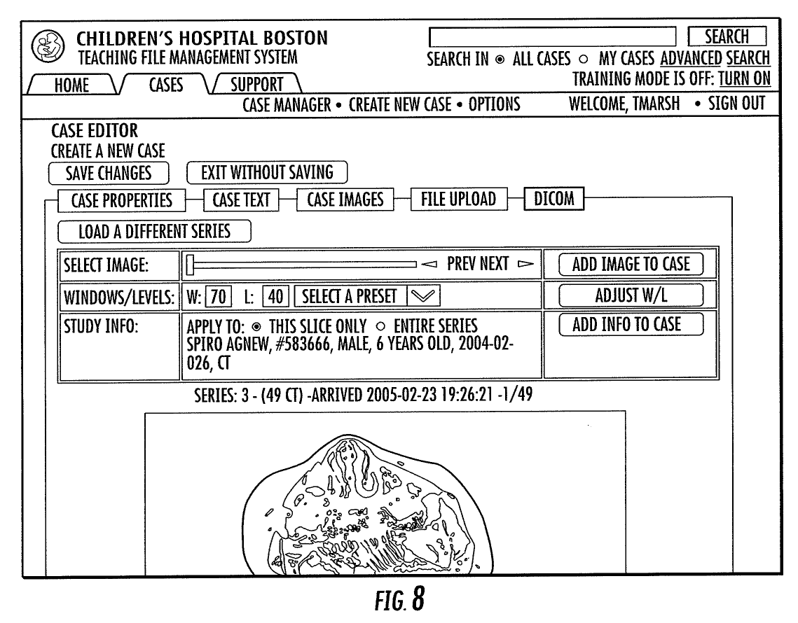

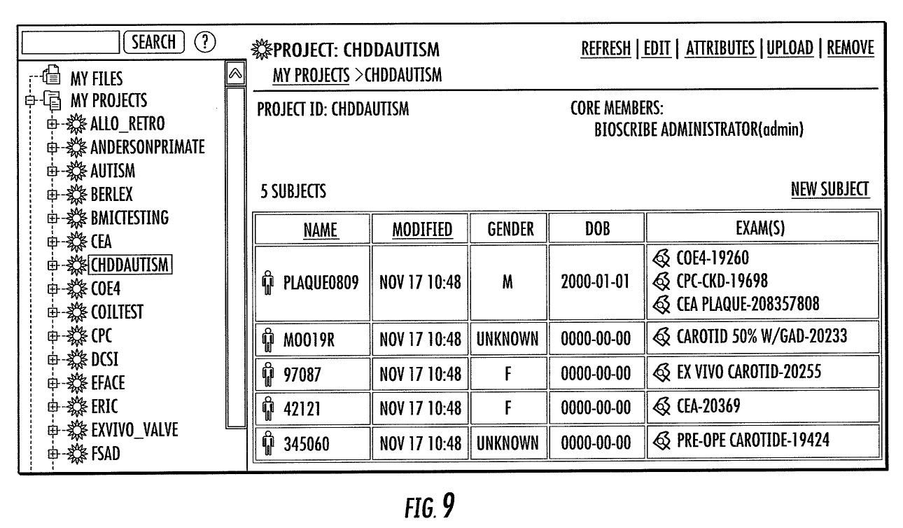

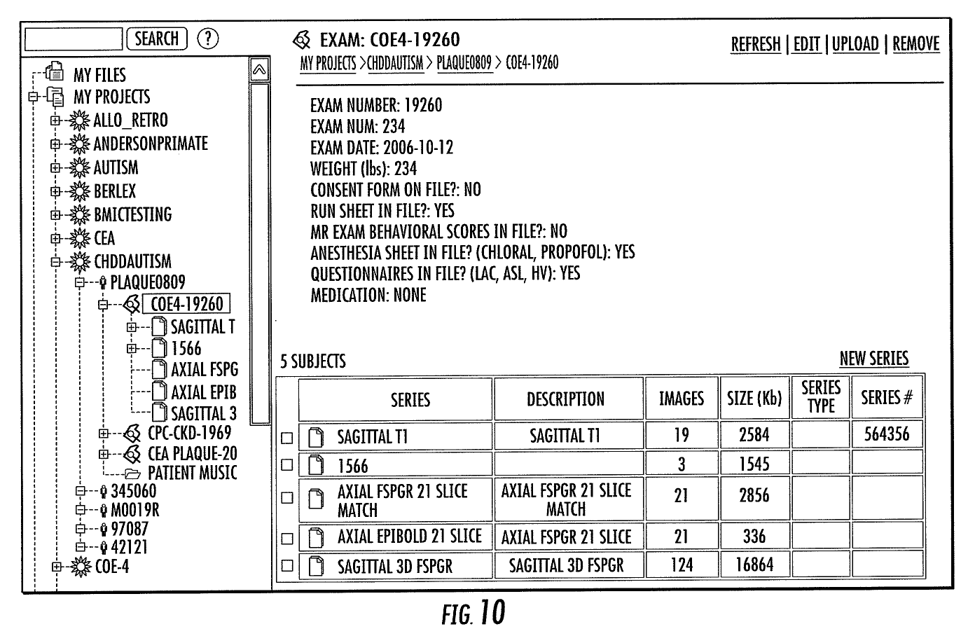

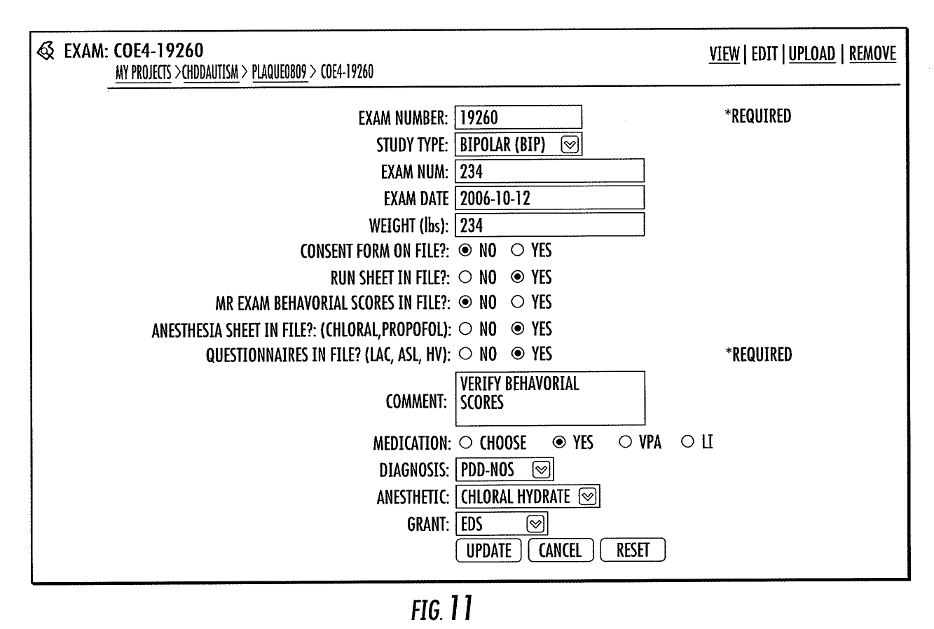

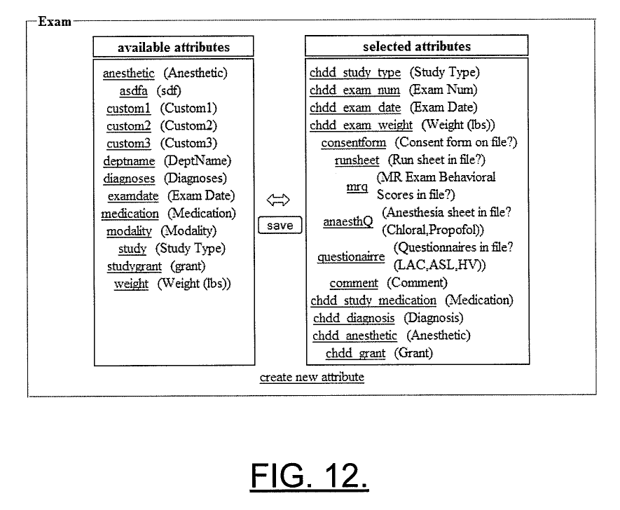

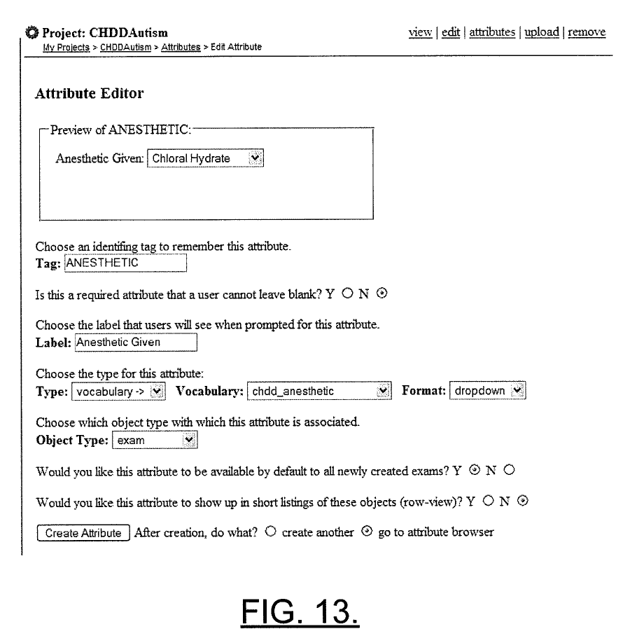

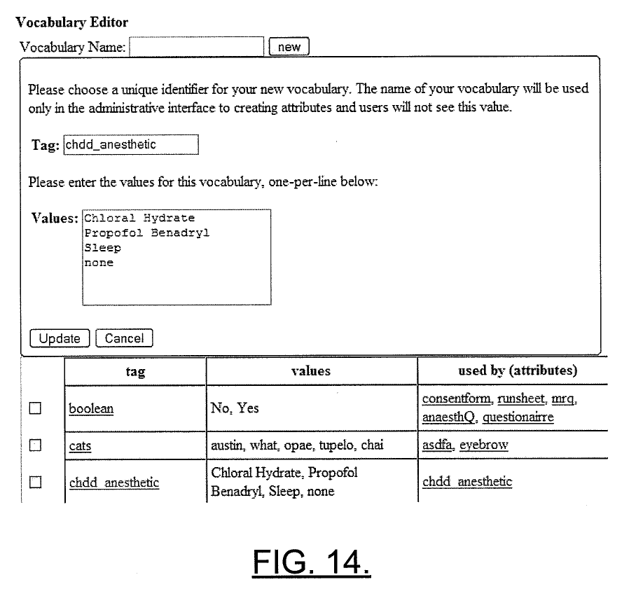

FIG. 5 illustrates an exemplary method for administering user access permissions associated with medical data content in a container according to an exemplary embodiment of the present invention. The method may comprise the data provision unit 128 receiving, from a client device 102, a user request to access medical data content of a container, at operation 400. Operation 410 may comprise the data provision unit 128 determining an identity of the user. The data provision unit 128 may determine access permissions associated with the container, at operation 420. Operation 430 may comprise the data provision unit 128 determining whether the user has permission to access the medical data content based at least in part upon the determined user identity and the determined access permissions. In some embodiments, this determination will be made based upon an identity of the client device 102 from which the request was received in addition to or in lieu of the identity of the user. Operation 440 may comprise the data provision unit 128 providing access to the requested medical data content if the user does have permission to access the medical data content. On the other hand, operation 450 may comprise the data provision unit 128 denying the request if the user does not have permission to access the medical data content.

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

### Example ADVANTAGEOUS EMBODIMENTS OF THE SYSTEM 100

Embodiments of the invention offer some or all of the following functionality:

Fine-grained sharing, with role-based access control and views tailored to the user based on his relationship to the data, and HIPAA-compliant privacy protection whereby data is anonymized but traceable to patient identity by authorized users.

Next-generation File System, in which the user manipulates objects rather than files. In this regard, DICOM objects may be mapped by the data provision unit 128 to a hierarchy of one or more folders. Objects may be seamlessly integrated with Microsoft® Windows® using, for example, Web-based Distributed Authoring and Versioning (WebDav), and can be accessed by remote collaborators over HTTPS. Rich user interface provides drag-and-drop access to files and objects through a web browser. Files and objects can be retrieved by structured queries over any attributes. DICOM objects and non-DICOM objects are unified in a single interface that provides drag-and-drop access to both types of objects in the browser and in Windows explorer. Users may associate non-DICOM files and directories with DICOM objects by simply dragging and dropping them onto the appropriate DICOM object. Users may add arbitrary attributes to DICOM and non-DICOM objects.

A rapid application development toolkit for easily constructing a set of user-friendly web-based structured reporting forms that are custom-tailored for each research project, allowing collaborating scientists and clinicians to submit data, report findings, and upload files from multiple institutions, regardless of geographic location.

A workflow management system that expedites data acquisition and processing through streamlined coordination of work steps, including the automated execution of sequential transformations, and an alert system that sends email to project members when their interaction is required. The system can include a web-based workflow monitoring console that can provide a visual overview of what's been done and what remains to be done for each experiment subject.

A scalable repository for storing data and files of any type, including acquired images, structured reports, processed data sets, statistical results, and visualizations. The schemas in the repository can be based on templates designed by the researchers, and can be fully customizable for representing the attributes and relationships of the project's unique data requirements. The repository can be integrated with the workflow manager, relieving researchers from the burden of managing files and coordinating inputs and outputs between processes.

A secure experiment subject navigator, allowing researchers to navigate through hierarchical data structures, generate reports, pose ad-hoc queries, and retrieve multimedia files from any authenticated web browser.

A policy manager that enables project leaders to selectively control access to data and files at a fine granularity, on a subject-by-subject and user-by-user basis, and to create custom reports showing different views over the data for different users and in different contexts.

An integrated ontology manager for importing or editing hierarchical structured vocabularies, which then are automatically integrated into the user interfaces for reporting, annotating, querying, disseminating, and navigating experiment data.

A connectivity toolkit for easily acquiring data from clinical systems, including DICOM-compliant PACS or modalities, and HL7-compliant EMRs.

A process wrapper interface for interfacing with scientific software tools (such as Analyze, MATLAB, SPSS, etc), allowing them to read and store data from the repository, to be semi-automated via wrappers that are launched from a web console and integrated with the workflow management interface.

Access control, encryption, and audit trails, providing a full log of every operation performed by every user. Access to images, studies, and experiment data are controlled through a digital asset management interface that allows users to specify who can see or edit objects at a fine level of granularity. For each project, users may specify core project members and collaborators, and control access based on each user's relationship to the data. Patient identifiers and other identifiers can be included or withheld from each view on a “need to know” basis.

When a new study is acquired, it is automatically routed to the appropriate project in accordance with embodiments of the invention based on DICOM header information. Email alerts keep project members informed of events, such as the arrival of a series that matches a subject registered to a specific project. Project members are prompted to enter additional metadata, such as study parameters and analysis type. Images and studies can be categorized by anatomy, pathology, modality, and experiment parameters. Any object or file in the system can be retrieved via full text search, or through advanced queries that allow users to compose constraints on combinations of attributes. To support user-friendly browsing and searching, embodiments of the invention generate a navigation trail at the top of each page, providing a visual context for traversing through hierarchical data.

Through secure web-based interfaces, embodiments of the invention allow geographically dispersed imaging researchers to create and maintain centralized repositories of multi-modal clinical images and their associated experiment data. Any type of file or exam can be imported into the repository, assigned metadata, and retrieved on demand through the web interface. Files can be sent via DICOM, uploaded through web browsers, or transferred to a secure FTP directory. Once in the repository, files can be tagged with keywords, grouped into web folders, and organized in structured hierarchies.

When a new study arrives in the system, it is automatically routed to the appropriate project Inbox based on metadata such as DICOM header information. Email alerts keep users informed of events, such as the arrival of a series that matches a subject registered to a specific project. Project members are prompted to enter additional metadata, such as study parameters and analysis type. Images and studies can be categorized by anatomy, pathology, modality, and experiment parameters. Any object or file in the system can be retrieved via full text search, or through advanced queries that allow users to compose constraints on combinations of attributes. To support user-friendly browsing and searching, embodiments of the invention generate a navigation trail at the top of each page, providing a visual context for traversing through hierarchical data.

In this regard, for example, a new DICOM object may be received by the data provision unit 128. The DICOM object may, for example, comprise a patient object. The data provision unit 128 may be configured to determine a parent group that may comprise a plurality of DICOM objects to which the DICOM object should be assigned. This group may be referred to as a “project” and may comprise a parent container including a plurality of hierarchies of one or more sub-containers to which DICOM objects have been mapped. For example, there may be multiple physicians in a medical practice and each physician may have his own “project” to which received DICOM objects relating to that physician may be mapped. Thus, for example, a physician project group may include one or more hierarchies of patient objects representing patients of the physician. In practice, for example, an attribute of a DICOM object may specify a referring physician and the data provision unit 128 may be configured to extract the attribute and attempt to match the data contained in the referring physician attribute to match the DICOM object to a group to which the DICOM object should be mapped. It will be appreciated, that the data provision unit 128 may be configured to extract data of any one or more attributes of a DICOM object in order to determine an appropriate group to which an incoming DICOM object should be mapped. The data provision unit 128 may then be configured to map the DICOM object to one or more containers within the determined group.

Web-Based Data Set Management and File Handling

Any type of file can be added to the repository. Each file or series can be assigned custom metadata, and retrieved on demand through the web interface. Files can be organized in a hierarchy and retrieved through a drill-down navigation interface. The system can include built-in metadata management, automatically keeping track of the date, owner, DICOM header fields, and other attributes. Files can either be viewed directly in the web browser (if the appropriate plug-in exists) or downloaded and opened by an external viewer. For example, if the repository contains an animated movie of a rotating 3D model, it can be viewed in the browser via the QuickTime plug-in.

DICOM Support

Files can be entered into the repository using a variety of methods. They can be pushed via a DICOM operation, uploaded through a web browser, transferred to an FTP directory, transmitted through WebDAV, or published via a web service. Embodiments of the invention implement the DICOM Storage Service Class Provider (SCP) so that users can push images to the System from any DICOM compliant source. It also implements the DICOM Query/Retrieve interface, so that any DICOM client can access studies that have been pushed to the System. The server supports a configurable number of distinct DICOM queues, each with its own port, allowing different groups to manage their own image directories.

Extended Connectivity Through Open Standards

Embodiments of the invention are able to exchange data with other data set management systems (including additional instances of invention software) in a secure, controlled dialog through open standards. The system communicates through standards such as RSNA MIRC to provide a central directory that can allow authorized users to make queries across multiple repositories, and to allow data sets to be transferred between repositories in a controlled fashion. In addition to the DICOM standard, all datasets in the system can be indexed and exported using the open RSNA MIRC format, and other XML standards. Data records can also be accessible directly through Structured Query Language (SQL). External applications can be integrated with the system by accessing the database through standard SQL API's, such as the Perl DBI module.

Security and Authentication

The system manages user sessions and passwords, requiring each user to maintain their own login and password information. Multiple groups can be defined within the system, and each group is able to control access to their own data and prevent access by members of other groups. Images and data can be retrieved from any secured authenticated web browser through a drill-down hypertext interface. Some basic groups are built into the system, including Core Member (who can do anything to project data), Collaborator (who can see most data and perform some operations). The system includes support for Secure Socket Layer (SSL) encryption, allowing all text and image data to be transmitted securely to the requesting browser. Security mechanisms are in place to support HIPAA compliance. All identifying information can be encrypted on transmission, and the access control facilities can be used to regulate who has access to identifiers. All access can be logged, and audit reports can be generated by the administrator at any time.

Embodiments of the invention efficiently manage studies on the order of terabytes in a central image server. The system avoids the overhead of redundant copying and uses efficient mechanisms for streaming data between client and server. The system allows any number of images, and the query interface is able to handle complex queries over millions of records in real time. The system can make efficient use of bandwidth, disk space, and processor power.

The system can include a browser-based JavaScript image viewer that allows images to by cycled in a stack, and allows adjustments to window and level settings. This viewer is integrated into the web browser and be easily launched directly from the web-based interface. In addition, the system is compatible with third party DICOM viewers.

The Data Set Manager (DSM) can be a web-based application that allows users to create, annotate, share, and navigate through image data sets and associated metadata.

Users may create virtual hierarchical folders to organize data according to their own preferences, and share these folders with other users.

User-friendly forms prompt for metadata, including project name, funding source, data domain, relevant identifiers, pathology and anatomy categories, imaging modalities and classifications, study parameters, and analysis type. Administrators can define which fields are enabled, disabled, required, or optional.

Administrators may see a list of all transactions in which a patient's identifiers were viewed. The system keeps a historical record of every transaction, and users are able to see who has accessed each data object, and whether or not private information was displayed.

While navigating through hierarchical structures, the system automatically generates a navigation index in the form of a set of links at the top of each page, providing a visual context for their traversal path, allowing them to easily return to a previous view.

The system can be configured to send email to a user on certain conditions, for example, when someone attaches a comment to their case.

Images imported into the system can be translated into JPEGs for viewing over the web at multiple resolutions. The system supports “images only mode”, which can allow images to be viewed on a black background without ambient light from surrounding text and banners. Users may also download images in their original format for viewing through a third party image viewer.

For most image types (including most DICOM files), the server can automatically translate the images into formats (such as JPEG) suitable for direct viewing in the browser. Images can be conveniently resized with a single click, and presented in thumbnail, medium, large, or in their original dimensions. The system can handle hundreds image formats, including DICOM, bitmaps, postscript, GIF, TIFF, and PNG.

Customizable Knowledge Management Interfaces.

Images and studies can be organized into groups based on experiment or research project, and annotated with keywords, pathological and anatomical categories, and other attributes to be determined. Repository objects can be retrieved via basic text matches on metadata, or through advanced queries that allow users to compose constraints on combinations of attributes. The Data Set Manager allows data to be organized and retrieved according to a custom hierarchy of categories. These attributes become part of the data set authoring, editing, querying, and viewing interfaces. Patient identifiers and accession numbers can be included or withheld from each view, and access to these fields can be regulated and monitored in compliance with HIPAA regulations.

The system can come with a web-based administrator console for managing user accounts, configuring the system, resetting passwords, and other maintenance operations.

Images, studies, and experiment data can be controlled through a digital asset management interface that allows users to regulate access to data at an arbitrarily fine level of granularity. Users are able to define their own groups for sharing access to objects (read-only or full edit capabilities). Users may create their own permissions groups, assign members to those groups, and regulate access to their data by group. For retrieving images, groups may designate their own DICOM port number, so images queued there can only be accessible by members of that group.

At least some of the above-described embodiments of the invention may be implemented via a modular approach, which may consist, for example, of twelve modules organized into five major components.

The EMS Designer can be used by researchers to configure and manage the structure of their experiment workflow, data model, access policies, data sources, and user interfaces. The Designer can consist of three primary components: the Knowledge Modeler, the Workflow Modeler, and the Interface Specification Toolkit. The Knowledge Modeler can provide web-based user interfaces for constructing formal schemas that capture the structure of each of the object types in the user's domain, including all relevant subject-oriented metadata. Additionally, it can provide a collaborative ontology manager that can allow users to import and edit structured vocabularies for organizing and indexing their experiment data. The Workflow Modeler can allow experiment designers to specify the workflow steps associated with an experiment and to specify roles and policies that can afford fine-grained access control over experiment data.

The Interface Specification Toolkit can provide a high level scripting environment that allows researchers to customize the WEMS user interfaces for acquiring, analyzing, and querying experiment data, and to create wrappers for external processes that serve as data sources and transformational filters. Using the EMS Designer, the system developer can generate a representation of the experiment that can include:

Subject-Oriented Repository Schemas that capture the structure (attributes and relationships) of each of the object types in the user's domain.

Workflow Specifications that describe every data source and every processing entity (script or interactive software application) that can participate in the transformation, processing, visualization, and analysis of data. For each entity, all relevant operations can be listed, including input and output parameters. Each of these operations can be eligible to participate in the experiment lifecycle as a node in the workflow graph. Each action can be assigned a process wrapper which can allow it to be controlled by the Workflow engine in accordance with embodiments of the invention. These actions can be threaded together in protocol graphs that describe the experiment workflow in terms of possible paths that the data can take through the processing entities. Ordering and synchronization requirements can be explicitly represented, as well as the path-level metadata not captured in the Subject-Oriented Schemas.

3. Policy Models that define user roles and declares policies indicating which operations can be performed by which roles. Access policies can include context-sensitive conditions, such as the workflow status of the subject being accessed.

The EMS-Generator can consist of two primary components: the Research Subject Manager and the Workflow Manager. The Subject Manager can allow researchers to securely navigate through experiment subjects. Users are able to view reports, generate ad hoc queries, drill down to subjects via categories, and organize subjects into shared folders. The Workflow Manager can assist researchers in managing their workflow, thereby reducing overhead, eliminating bottlenecks, reducing the delay between stages of processing, and freeing the project from the need for a single person who coordinates every step. This can be accomplished by employing various techniques for managing the dependencies between workflow stages. The system can include a Monitor Console that can allow remote project members to easily monitor each other's experiments, providing a web-based overview of what remains to be done for each experiment subject and an audit trail for every transaction that was performed. The workflow system can be tightly integrated with the multimedia repository, automatically coordinating the inputs and outputs of participating processes. In this way, researchers can be relieved of the burden of managing files and metadata, and instead by free to interact with their data at a more natural level of abstraction.

Various embodiments, as described above, or otherwise, can exhibit some or all of the following innovations:

EMS Designer Component 1: Knowledge Modeler Module

This module can allow system designers to add structure to their data so that it can be easily queried and aggregated with other data sources. The collaborative authoring of knowledge structures is essential to bridging the semantic heterogeneity inherent in clinical research projects that span multiple disciplines and communities. The Knowledge Modeler can accomplish this through two primary tools: the Schema Manipulator, and the Ontology Manager.

The Schema Manipulator or Attribute Editor can allow users to define the structure of the objects related to their experiments, thereby facilitating deep knowledge modeling of relevant clinical concepts. Each object can be comprised of a set of named attributes and their corresponding data formats. Attributes may be either atomic (numeric and text fields), pointers to structured vocabularies, or references to other objects. The Schema Manipulator can provide a wizard-like interface for guiding the user through the specification of their domain. Users can be prompted to select from existing templates for common experiment objects (e.g. patients, exams, findings, etc) and customize those templates by selecting from a set of predefined attributes and/or adding new attributes. The tool can also allow existing schemas to be modified in place. Attributes can be added, renamed, or deleted. The Schema Manipulator can enable domain experts to easily create their own models, rather than requiring the assistance of a developer. By lowering the bar for schema modeling and evolution, the resulting experiment data can be more accurately structured, and consequently it can be easier to analyze, query, and integrate with external systems. These models can be used by the EMS Generator to provide a subject-oriented browser that is custom-tailored for the researcher's data. Attributes can be scoped by object type (e.g. Subject, Exam) or be available to all object types. The scoping can be global (for all projects), or on a project-by-project basis. The attribute manager can consist of an interface for creating new attributes and an interface for specifying which attributes should be associated with which object classes. The interface for creating attributes allows the user to specify the name, type, and prompt for the attribute, as well as the form type that should be used (e.g. radio buttons, dropdown menu, checkboxes, etc). The interface for assigning attributes can allow the user to specify an ordering of attributes as they should appear in data collection forms.

The Vocabulary Editor and/or Ontology Manager can allow users to define new structured vocabularies (flat or hierarchical), as well as import existing vocabularies into their EMS, edit those vocabularies, and create mappings between pairs of ontologies (alignment). Hierarchical vocabularies can be edited using a web-based tree-browser interface embedded directly in the EMS user interface. The system can enable users to adopt structured vocabularies for organizing and indexing their experiment data. Ontologies can be tightly integrated into the content management features of the EMS. The range of values for each schema attribute can be associated with a particular concept hierarchy, which can cause the EMS Generator to create interfaces that incorporate cascading menus for assigning the appropriate concept to each attribute during data acquisition or editing. Similarly, the interfaces for querying or drilling down into a set of data can be augmented with ontology navigation tools. This is the first time such technology is directly integrated into an experiment management system, making it possible to edit ontologies directly at the point of annotation, while they are being used to organize content. Because the interfaces can be web-based, users are able to collaboratively manage ontologies from any web browser, without having to have access to special software. The power of integrating these two technologies greatly enhances the ability for biomedical professionals to manage their data. The ontologies imported or constructed by the Ontology Manager can become part of the Research Subject Manager user interfaces, for drill-down navigation, structured reporting (attaching values to subject attributes), and querying.

Vocabularies can be stored in the repository database using terms and links tables. The front-end can be constructed using JavaScript tree browsers and hierarchical menus. To support the importing of ontologies, the Ontology Manager can use the Ontology Interchange Language (OIL), an XML-based exchange format for ontologies. For ontologies that are not represented in OIL, filters can be employed for marking up text-based ontologies in preparation for importing via the OM I.

EMS Designer Component 2: Workflow Modeler Module (WMM)

This module can enable domain experts to design the experiment lifecycle, including stages for data collection, analysis, interpretation, reporting, validation, and dissemination. The WMM can consist of two modules: the Experiment Lifecycle Designer, and the Policy Manager Interface.

The Experiment Lifecycle Designer (ELD) can allow experiment designers to specify the workflow steps associated with an experiment. For each step, the users can specify 1) what action can be taken, 2) what data can be affected, 3) what dependencies that step has on other steps in the workflow, and 4) what alerts or triggers should be automatically executed on the completion of the step. The steps can be subject-oriented, that is, each step can focus on the flow of experiment data through a set of operations or filters. Each step can be linked to a class method (such as the Exam Acquisition method), or a script generated by the Wrapper Module (see below). The ELD can also support the importing and exporting of workflow from external applications, using the XML Process Definition Interface (XPDL) interchange format and the Workflow Reference Model, as specified by the Workflow Management Coalition. A declarative workflow interface can provide a visual framework that assists the researcher in mapping the processes involved in the experiment, including the collection and analysis of data, and the preparation of findings for distribution. By automatically managing dependencies and automating alerts, the system can reduce the overhead in keeping the experiment process flowing. The declarative output of the ELD can provide a mechanism for monitoring experiment status. Also, it can allow experimenters to keep an audit trail of every transaction involving their experiment data. By supporting the importing and exporting of workflow from external applications, the EMS is able to participate in enterprise-wide distributed workflow systems. The Workflow Specification Interface can allow scientists to identify actions to be performed, associate those actions with software applications or executable scripts, map out the flow of data between those processes, and designate the roles of users who can be called upon to interact with the workflow.

The ELD can allow experiment designers to specify the workflow steps associated with an experiment. The interface can allow users to link steps to class methods or wrappers. The ELD can also support the importing and exporting of workflow from external applications, using a representation such as the XML Process Definition Interface (XPDL) interchange format. The ELD can consist of a set of forms for editing workflow metadata. The front end can include a java applet that allows the inputs and outputs of each step to be linked together graphically in a flowchart-like environment. Workflow steps can be represented as repository objects and stored in the relational database. The EMS Generator can read the workflow steps and translate them into an executable console interface for managing the experiment. Workflow steps that are associated with class methods can cause those methods to be invoked when the step is executed. Those which are linked to a script can cause the appropriate script to be invoked. Data flow can be piped from the repository to the processes using connections such as DBI. The Workflow Reference Model can be implemented using a standard such as the Workflow Client API standard. Alerts can be handled by an Asynchronous Communication Agent, which can send emails and push updates to client browser sessions.

The Policy Manager can allow researchers to share precisely what they want, when they want, with whom they want. Without fine-grained access control, researchers would be forced to adhere to overly restrictive policies or risk violating HIPAA regulations or exposing private research data. The Policy Manager can allow experiment designers to specify roles and custom-tailor access to workflow steps based on these roles. For example, roles may be “investigator”, “core member”, “collaborator”, “administrator”, etc. Policies can be defined as access relationships between roles and actions. For example, a policy may be “administrators may edit any data element”, “collaborator does not see patient identifiers”. Policies may be specified at an arbitrarily fine granularity, distinguished by multiple views over the same data. The PMI can allow researchers to control access to views of data (such as custom reports or cross-sections of subject records) and actions on data (such as launching a processing routine on a particular volume). Capabilities can be associated with a class or with a particular instance.

EMS Designer Component 3: Interface Specification Toolkit (IST)

The IST can allow researchers to customize the EMS user interfaces for acquiring, analyzing, and querying experiment data, and to create wrappers for external processes that serve as data sources and transformational filters. The IST can consist of two modules: the Wrapper Toolkit and the Subject Constructor.

The Wrapper Toolkit can allow external processes to be encapsulated in scripts that launch them, including a specification of all inputs and outputs. Three kinds of processors can be supported: data sources, filters, and sinks. The Wrapper Toolkit can provide the necessary hooks allowing processes to be virtually “strung together” in paths by the Experiment Lifecycle Designer. Any kind of entity can be wrapped, as long as it can be launched by an external process that specifies parameters using a command-line interface or remote procedure calls. This can include MATLAB programs, SPSS scripts, Insight Toolkit applications, etc. It also may include launching interactive programs such as SPM or Analyze. For each processor, system developers can modify a supplied wrapper template to specify mappings between the inputs and outputs of the processor to the appropriate attributes of the Repository Schemas of the experimental subjects. In this way, the end-user can be freed from needing to know the locations and names of files.

The wrapper toolkit can allow data to be read into and out of the repository by mapping inputs and outputs to the appropriate attributes of the Repository Schemas of the experimental subjects.

The Subject Constructor provides a high level scripting interface to create the appropriate View Methods and Edit Methods for each schema class. The scripting environment provides utilities to create context-sensitive interfaces that can enable the EMS Generator to create the necessary drill-down visualization interface.

The EMS Generator

The EMS Generator application can be a server that automatically reads in an EMS-ML instance and generates a custom WEMS. The EMS-Generator can consist of two primary components: the Research Subject Manager and the Workflow Manager. Each of these is described below.

EMS Generator Component 1: Research Subject Manager

Using the schema specifications and custom views defined by the EMS Designer, and adhering to the policies defined by the PMI, the Subject Manager can allow researchers to securely navigate through experiment subjects. Users are able to view reports, generate ad hoc queries, drill down to subjects via categories as defined by the Ontology Manager, organize subjects into virtual folders, and perform workflow operations from a subject-oriented perspective. All files imported into the system can have metadata automatically maintained, using a format such as the DUBLIN CORE metadata format.

EMS Generator Component 2: Workflow Manager

The Workflow Manager can assist researchers in managing their workflow, thereby reducing overhead, eliminating bottlenecks, reducing the delay between stages of processing, and freeing the project from the need for a single person who coordinates every step. This can be accomplished by employing various techniques for managing the dependencies between workflow stages.

The Monitor Console can allow remote project members to easily monitor each other's experiments, providing a web-based overview of what remains to be done for each experiment subject and an audit trail for every transaction that was performed. The system can provide a visual overview of what has been done and what remains to be done for each experiment subject. The console can be rendered as a table whose columns correspond to actions and rows correspond to experiment subjects. If a stage is ready to be executed, and the user is authorized to perform that stage, a hyperlink can appear in the appropriate cell, which can launch that process on the appropriate subject. For operations that have already been performed, a hyperlink can take the user to the relevant intermediate data set associated with that operation. The system can be tightly integrated with the multimedia repository, automatically coordinating the inputs and outputs of participating processes. In this way, researchers can be relieved of the burden of managing files and metadata, and instead by free to interact with their data at a more natural level of abstraction. For example, to segment the data for a particular patient, the researcher can simply navigate to a control page for that patient, drill down to the appropriate exam page, then click a link labeled “perform segmentation”, which can generate a configuration script on the fly that launches the necessary MATLAB program on the appropriate input files, stores the output files in the repository, and summarizing the results of the operation in the user's web browser. The Monitor Console can allow experimenters to keep an audit trail of every transaction involving their experiment data.

By automatically managing dependencies and automating alerts, the Execution Engine can reduce the overhead in keeping the experiment process flowing. The Execution Engine can facilitate the virtual stringing together of processing entities by launching each one and controlling the flow of data between them. The Execution Engine can also support the importing and exporting of workflow from external XPDL-compliant applications, thereby enabling the EMS to participate in enterprise-wide distributed workflow systems (including the chaining together of multiple independent WEMS). The Engine can automatically execute sequential processes that don't require user interaction when their inputs are available, and (2) send email or instant messages when a project member's attention is required. For example, the system could be configured to alert the imaging specialist whenever the radiology technician imports a new MR series.

The system can make use of workflow techniques and standards, such as the XML Process Definition Language (XPDL), which can ensure that researchers are able to connect their experiments to other workflow-oriented applications. The Execution Engine can pipe the flow of data directly between processes, or it can require processes to communicate indirectly by marshalling data in and out of the repository.

Embodiments of the invention can make use of some of the following innovations, applied for the first time to research data management:

WebDAV access to an object database with access control. Create an interface between back-end framework (i.e., Catalyst) and incoming HTTP traffic. Interface is responsible for translating all incoming DAV requests into corresponding object accessors. Permissions from objects are translated in reverse to DAV error messages indicating whether or not a user is allowed to access the object. Furthermore, interface allows for translation of file names into arbitrary names, giving the user the appearance that they are seamlessly interacting with a file system when they are truly querying a relational or object database.

Live upload & download indicators in browser without plug-in. upload indicator. when a user has selected multiple files for upload, an event is attached to the form submission such that when the form is submitted, a dynamic iframe appears on the page which polls server with a small (1-5 second) period to see what the status of the temporary file being uploaded is. This status is displayed on the webpage giving the user an indicator of their upload progress. This is a completely novel application of Ajax. A timeout is also setup upon form submission so as to periodically verify that upload is still in progress (computed by comparing browser and server side checksums), alerting the user if it is interrupted for any reason.

Download indicator in browser without plug-in. Hidden iframe with periodic polling to server updates a DOM element that represents the state of the downloaded object.

AJAX search. asynchronous submission of a search query allowing the display of previous results until new results have been returned and presenting the results in an optionally scrollable hierarchical representation, which allows for a compact representation of the entire result set that can be expanded by selecting a particular level of the hierarchy until a final result items are revealed.

Automatic metadata inclusion. Automatic inclusion of file metadata such as DICOM header information to an aggregation when that file is added to the aggregation. Any client-side representation of the aggregation is updated instantly.

Permission/rule-based drag and drop in browser. Attach events to DOM elements' mouse-over event. While dragging DOM elements compute intersection of elements and compare to a static JSON representation of intersection rules. If session configuration indicates permission to drag element over the other element, signal by changing the appearance of the dragged image with decoration (i.e. red border for no, green border for yes, “X” background for no) to signify whether or not you are allowed to drop the item. When mouseup event is fired, consult same rules to verify that user has permission to drag. Similarly, re-enforce rules on the backend to prevent users from communicating drag event to server from some other application.

Creating dynamic attributes in web-based application. While selecting styles for attributes (dropdown, radio, free text, text area, etc) events are fired that cause an asynchronous update of a hidden iframe embedded in the application page. The iframe contains the very same template that is later used to render the attribute, thus providing the user with an exact representation of the future attribute.

Asynchronous HTTP submission. Submission of data via HTTP not requiring the originating webpage to refresh its contents or be redirected to another location. If a relevant response is generated from the processing of the submission, the originating webpage (or any other related webpage) can be updated programmatically without need for fully refreshing its contents or being redirected to another location.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
mapping a Digital Imaging and Communications in Medicine (DICOM) object comprising medical data content to a hierarchy of one or more containers, wherein each container comprises a subset of the medical data content of the DICOM object; and
providing a user interface allowing a user to view a representation of the hierarchy and access the medical data content of the one or more containers.

2. A method according to claim 1, wherein providing a user interface comprises providing a user interface allowing the user to add data to a container; and further comprising:
receiving data that a user has added to a container; and
associating the received data with the DICOM object based at least in part upon the container to which the received data was added.

3. A method according to claim 2, wherein:
receiving data comprises receiving data not formatted in conformance with DICOM standards; and
associating the received data with the DICOM object comprises:
modifying the received data so that it is compatible with the DICOM object; and
adding the modified received data to the DICOM object based at least in part upon the container to which the received data was added.

4. A method according to claim 1, wherein providing a user interface comprises providing a user interface allowing a user to view the hierarchy of containers as a hierarchy of folders and providing a graphical drag and drop interface allowing a user to add data to a folder.

5. A method according to claim 1, wherein mapping a DICOM object comprises:
determining access permissions defined by the DICOM object for one or more subsets of the medical data content of the DICOM object; and
associating a determined access permission with a container based at least in part upon the subset of the medical data content included in the container.

6. A method according to claim 5, further comprising:
receiving a request from a user to access medical data content of a container;
determining an identity of the user;
determining access permissions associated with the container;
determining whether the user has permission to access the medical data content of the container based at least in part upon the determined identity and the determined access permissions;
providing the user access to the requested medical data content if the user has permission to access the medical data content; and
denying the user request if the user does not have permission to access the requested medical data content.

7. A method according to claim 1, wherein the DICOM object is a patient object comprising one or more exam objects; and
wherein mapping the DICOM object comprises mapping medical data content of each exam object to a separate container.

8. A method according to claim 1, wherein the DICOM object is an exam object comprising one or more series objects; and
wherein mapping the DICOM object comprises mapping medical data content of each series object to a separate container.

9. A computer program product comprising at least one computer-readable storage medium having computer-readable program instructions stored therein, the computer-readable program instructions comprising:
a program instruction for mapping a Digital Imaging and Communications in Medicine (DICOM) object comprising medical data content to a hierarchy of one or more containers, wherein each container comprises a subset of the medical data content of the DICOM object; and
a program instruction for providing a user interface allowing a user to view a representation of the hierarchy and access the medical data content of the one or more containers.

10. A computer program product according to claim 9, wherein the program instruction for providing a user interface comprises instructions for providing a user interface allowing the user to add data to a container; and further comprising:
a program instruction for receiving data that a user has added to a container; and
a program instruction for associating the received data with the DICOM object based at least in part upon the container to which the received data was added.

11. A computer program product according to claim 10, wherein:
the program instruction for receiving data comprises instructions for receiving data not formatted in conformance with DICOM standards; and
the program instruction for associating the received data with the DICOM object comprises:
a program instruction for modifying the received data so that it is compatible with the DICOM object; and
a program instruction for adding the modified received data to the DICOM object based at least in part upon the container to which the received data was added.

12. A computer program product according to claim 9, wherein the program instruction for providing a user interface comprises instructions for providing a user interface allowing a user to view the hierarchy of containers as a hierarchy of folders and providing a graphical drag and drop interface allowing a user to add data to a folder.

13. A computer program product according to claim 9, wherein the program instruction for mapping a DICOM object comprises:
a program instruction for determining access permissions defined by the DICOM object for one or more subsets of the medical data content of the DICOM object; and
a program instruction for associating a determined access permission with a container based at least in part upon the subset of the medical data content included in the container.

14. A computer program product according to claim 13, further comprising:
a program instruction for receiving a request from a user to access medical data content of a container;
a program instruction for determining an identity of the user;
a program instruction for determining access permissions associated with the container;
a program instruction for determining whether the user has permission to access the medical data content of the container based at least in part upon the determined identity and the determined access permissions;
a program instruction for providing the user access to the requested medical data content if the user has permission to access the medical data content; and
a program instruction for denying the user request if the user does not have permission to access the requested medical data content.

15. An apparatus comprising a processor configured to:
map a Digital Imaging and Communications in Medicine (DICOM) object comprising medical data content to a hierarchy of one or more containers, wherein each container comprises a subset of the medical data content of the DICOM object; and
provide a user interface allowing a user to view a representation of the hierarchy and access the medical data content of the one or more containers.

16. An apparatus according to claim 15, wherein the processor is configured to provide a user interface by providing a user interface allowing the user to add data to a container; and wherein the processor is further configured to:
receive data that a user has added to a container; and
associate the received data with the DICOM object based at least in part upon the container to which the received data was added.

17. An apparatus according to claim 16, wherein the processor is configured to receive data by receiving data not formatted in conformance with DICOM standards; and
associate the received data with the DICOM object by:
modifying the received data so that it is compatible with the DICOM object; and
adding the modified received data to the DICOM object based at least in part upon the container to which the received data was added.

18. An apparatus according to claim 15, wherein the processor is configured to provide a user interface by providing a user interface allowing a user to view the hierarchy of containers as a hierarchy of folders and providing a graphical drag and drop interface allowing a user to add data to a folder.

19. An apparatus according to claim 15 wherein the processor is configured to map a DICOM object by:
determining access permissions defined by the DICOM object for one or more subsets of the medical data content of the DICOM object; and
associating a determined access permission with a container based at least in part upon the subset of the medical data content included in the container.

20. An apparatus according to claim 19, wherein the processor is further configured to:
receive a request from a user to access medical data content of a container;
determine an identity of the user;
determine access permissions associated with the container;
determine whether the user has permission to access the medical data content of the container based at least in part upon the determined identity and the determined access permissions;
provide the user access to the requested medical data content if the user has permission to access the medical data content; and
deny the user request if the user does not have permission to access the requested medical data content.
